(19) United States
(12) Patent Application Publication
(10) Pub. No.: US 2018/0177351 A1
(43) Pub. Date: Jun. 28, 2018

(54) WASHING APPARATUS WITH OPERATOR STATION

(71) Applicants: Michael Richard Lange, Little Canada, MN (US); Robert John Blake, Wayzata, MN (US)

(72) Inventors: Michael Richard Lange, Little Canada, MN (US); Robert John Blake, Wayzata, MN (US)

(21) Appl. No.: 15/691,512

(22) Filed: Aug. 30, 2017

Related U.S. Application Data
(60) Provisional application No. 62/381,366, filed on Aug. 30, 2016.

(51) Int. Cl. A47L 3/02; A47L 1/02; B08B 1/04; B08B 1/00; B08B 3/04

(52) U.S. Cl. CPC A47L 3/02; A47L 1/02; B08B 3/04; B08B 1/002; B08B 1/04

(57) ABSTRACT

The washing apparatus includes a platform that includes an operator station. The platform is adapted to move along the upright surface during cleaning. The platform is positionable along the upright surface along a length of the platform. The washing apparatus includes a powered cleaning structure that has cleaning elements that are adapted to contact the upright surface during cleaning. The powered cleaning structure is supported by the platform along at least a portion of the length of the platform. The washing apparatus includes a hoist system constructed and arranged to move the platform along the upright surface of the structure with lift cables.

### PRIORITY

This application claims the benefit of U.S. Provisional Application Ser. No. 62/381,366, filed on Aug. 30, 2016, which is hereby incorporated herein by reference in its entirety.

### BACKGROUND

Building structures, particularly tall urban buildings, are frequently washed manually. This is often done by suspending a window washer operator alongside a building via a suspended platform, a swing stage or suspended scaffolding. However, manually washing windows can be time consuming and subject to operator error. Further, controlling the motion of the window washer operator relative to the side of the building is also important for the safety of the operator. Controlling such motion can become problematic on windy days. Improvements are desirable.

### SUMMARY

The present disclosure relates generally to a washing apparatus for cleaning an upright surface of a structure. In one possible configuration, and by non-limiting example, the washing apparatus includes a cleaning apparatus supported by a platform with an operator station.

In a first aspect of the present disclosure, a washing apparatus for cleaning an upright surface of a structure is disclosed. The washing apparatus includes a platform that includes an operator station. The platform is adapted to move along the upright surface during cleaning. The platform is positionable along the upright surface along a length of the platform. The washing apparatus includes a cleaning structure that has cleaning elements that are adapted to contact the upright surface during cleaning. The cleaning structure is supported by the platform along at least a portion of the length of the platform. The washing apparatus includes a hoist system constructed and arranged to move the platform along the upright surface of the structure with lift cables.

In another aspect of the present disclosure, a washing apparatus for cleaning an upright surface of a structure is disclosed. The washing apparatus includes a platform that includes an operator station and a railing at least partially surrounding the operator station. The platform is adapted to move along the upright surface during cleaning. The platform is also positionable along the upright surface along a length of the platform. The washing apparatus includes securing features attached to the platform. The securing features are configured to secure the platform to the upright surface. The washing apparatus includes a powered cleaning structure that includes cleaning elements adapted to contact the upright surface during cleaning. The powered cleaning structure is supported by the platform along at least a portion of the length of the platform. The washing apparatus includes a hoist system attached to the platform. The hoist system is configured to move the platform along the upright surface of the structure with lift cables.

In another aspect of the present disclosure, a washing apparatus for cleaning an upright surface of a structure is disclosed. The washing apparatus includes a platform that includes an operator station and a railing at least partially surrounding the operator station. The platform is adapted to move along the upright surface during cleaning. The platform is positionable along the upright surface along a length of the platform and the operator station extends along the length of the platform. The washing apparatus includes securing features attached to the platform. The securing features are configured to secure the platform to the upright surface. The washing apparatus includes a powered cleaning structure that includes cleaning elements adapted to contact the upright surface during cleaning. The powered cleaning structure is supported by the platform along at least a portion of the length of the platform. The washing apparatus includes a hoist system attached to the platform. The hoist system is configured to move the platform along the upright surface of the structure with lift cables.

A variety of additional aspects will be set forth in the description that follows. The aspects can relate to individual features and to combinations of features. It is to be understood that both the foregoing general description and the following detailed description are exemplary and explanatory only and are not restrictive of the broad inventive concepts upon which the embodiments disclosed herein are based.

### BRIEF DESCRIPTION OF THE DRAWINGS

The following drawings are illustrative of particular embodiments of the present disclosure and therefore do not limit the scope of the present disclosure. The drawings are not to scale and are intended for use in conjunction with the explanations in the following detailed description. Embodiments of the present disclosure will hereinafter be described in conjunction with the appended drawings, wherein like numerals denote like elements.

FIG. 1 illustrates a perspective view of a washing apparatus according to one embodiment of the present disclosure;

FIG. 2 illustrates a side view of the washing apparatus of FIG. 1;

FIG. 3 illustrates a schematic side view of a washing apparatus with a cleaning structure in a lowered position, according to one embodiment of the present disclosure;

FIG. 4 illustrates another schematic side view of the washing apparatus of FIG. 3 with the cleaning structure in a raised position;

FIG. 5 illustrates another schematic side view of the washing apparatus of FIG. 3 without a cleaning structure frame and with the cleaning structure in a lowered position;

FIG. 6 illustrates another schematic side view of the washing apparatus of FIG. 3 without a cleaning structure frame with the cleaning structure in a raised position;

FIG. 7 illustrates a schematic side view of a washing apparatus with a cleaning structure in a lowered position, according to one embodiment of the present disclosure;

FIG. 8 illustrates another schematic side view of the washing apparatus of FIG. 7 with the cleaning structure in a raised position;

FIG. 9 illustrates a schematic side view of a washing apparatus, according to one embodiment of the present disclosure;

FIG. 10 illustrates a schematic side view of a washing apparatus, according to one embodiment of the present disclosure; and

FIG. 11 illustrates a schematic top view of a washing apparatus, according to one embodiment of the present disclosure.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

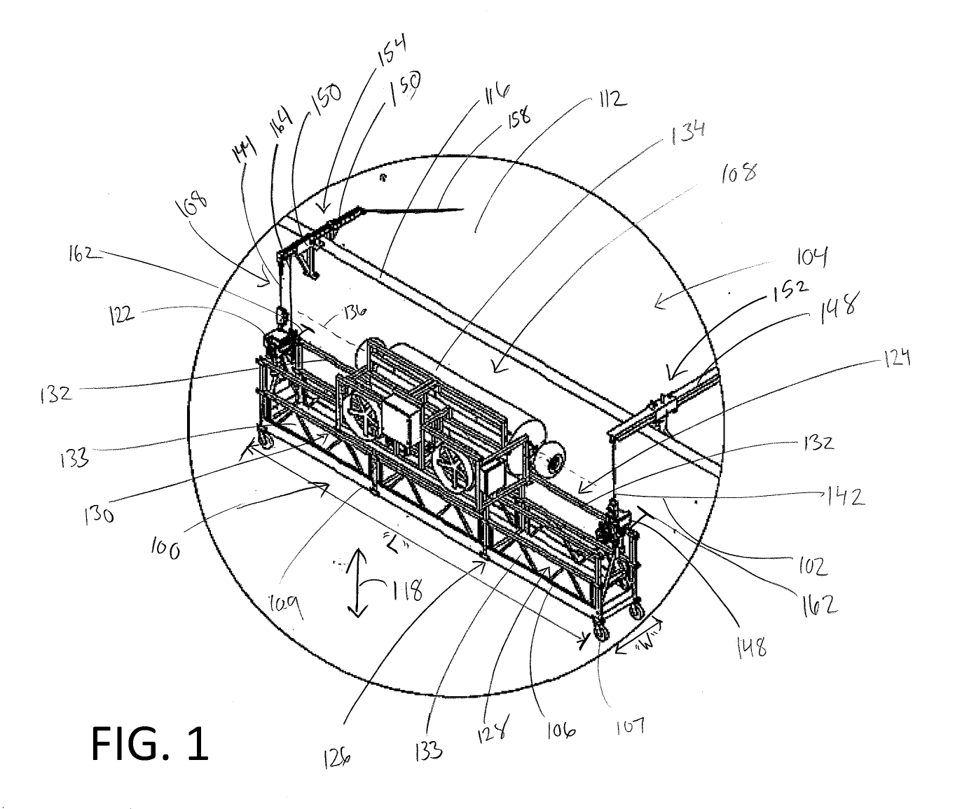

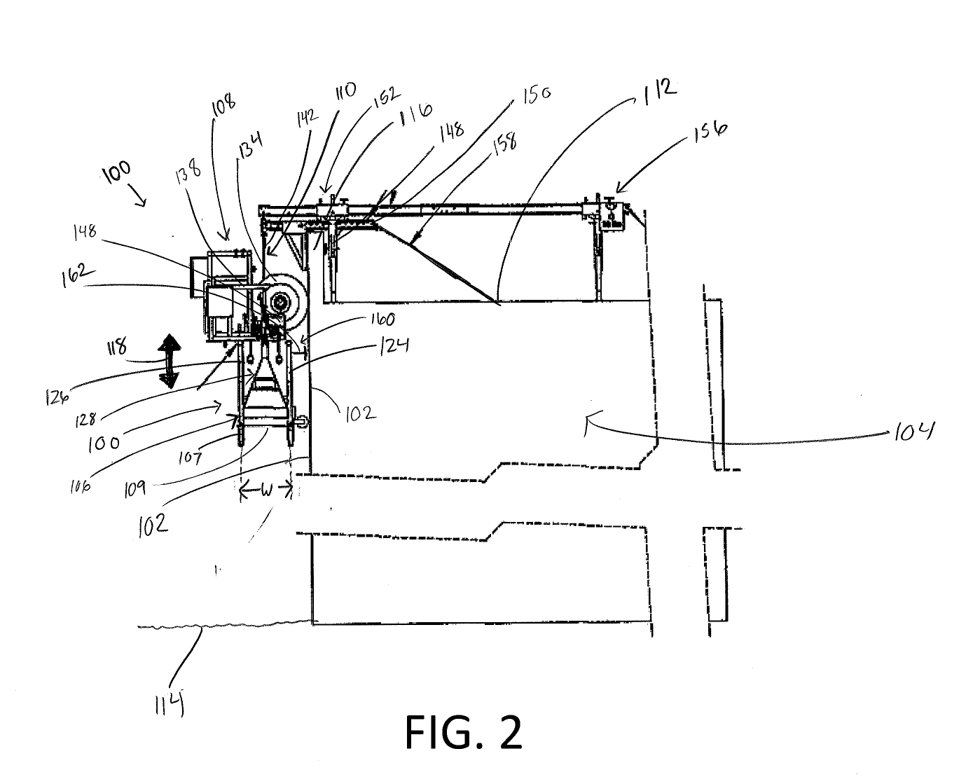

FIG. 1 illustrates a perspective view of a washing apparatus 100. FIG. 2 illustrates a side view of the washing apparatus 100. The washing apparatus 100 is shown on an upright surface 102 of a structure 104. The washing apparatus 100 includes a platform 106 (i.e., suspended platform, swing stage, suspended scaffolding, etc.), a cleaning structure 108 supported by the platform 106, and a hoist system 110. In one example, the cleaning structure is a powered cleaning structure having one or more cleaning elements that are driven relative to the platform by a power source. In certain examples, the cleaning element or elements can include a brush or brushes. In certain examples, the brush or brushes are driven in a rotary motion relative to the platform. In certain examples, the power source includes one or more motors such as one or more electric motors, or one or more combustion engines. In some examples the washing apparatus 100 is a specialty manufactured apparatus. In some examples, the cleaning device can be an add on device that can be added to an existing platform to temporarily or permanently retrofit the platform so as to include automated cleaning features. Alternatively, the cleaning device can be incorporated into the platform at the time the platform is initially manufactured. In other examples an existing pre-manufactured platform 106 can be modified to arrive at the washing apparatus.

The structure 104 can be a building, such as a skyscraper or high-rise building. The upright surface 102 can be the side of the building including, for example, windows or the structure of the building between the windows. The structure 104 has a roof 112 and is resting on a ground surface 114 (shown in FIG. 2). It should be understood that the ground surface 114 can be anything that the structure 104 is resting on, including, other parts of the building, for example a tiered building having other intermediate setbacks or roofs. In addition, in the depicted embodiment, the roof 112 includes a parapet wall 116 positioned at the edge of the roof 112 and raised above the roof 112. In addition, the roof 112 illustrated can be something other than the very highest ultimate roof of the building, but could be intermediate setbacks or intermediate roofs.

The washing apparatus 100 is shown cleaning the upright surface 102 of the structure 104. The washing apparatus 100 is configured to move in a vertical direction 118 along upright surface 102 during cleaning. The washing apparatus 100 is generally movable by the hoist system 110.

The platform 106 of the washing apparatus 100 is configured to support the cleaning structure 108. The platform 106 can also be known as suspended platform, a swing stage or suspended scaffolding. The platform 106 is connected to and movable by the hoist system 110. The platform 106 has a front side 124 and a back side 126 separated by a width W. The front side 124 and the back side 126 define a length L of the platform 106 which is greater than the width W. The platform 106 is positionable along the upright surface 102 along the length L of the platform 106. When in operation, the front side 124 of the platform 106 is closest to the upright surface 102 of the structure 104. When not in operation, the platform 106 can be moved along a flat surface such as the roof 112 using wheels 107 mounted at a bottom side 109 of the platform 106. In some embodiments, the wheels 107 are lockable so as to prevent the platform 106 from inadvertently rolling along a flat surface.

The platform 106 also includes at least one operator station 128. In the depicted embodiment, the platform 106 includes two operator stations 128, 130. In other embodiments, the platform 106 includes more than two operator stations 128, 130. In some embodiments, a single operator can occupy an operator station. In other embodiments, multiple operators can occupy an operator station. The operator stations 128, 130 are spaces that operators can occupy while the washing apparatus 100 is being operated. The operator stations 128, 130 allow the operator or operators access to the different components of the washing apparatus 100. For example, the operator stations 128, 130 can be configured to allow the operator access to the cleaning structure 108 to control its operation and or to portions of the hoist system 110 to operate the motion of the washing apparatus 100. In some embodiments, the operator stations 128, 130 include tethering locations for the operator to secure himself to the washing apparatus 100. In one example, the operator stations can be at the ends of the platform with the cleaning structure between the stations. In another example, an operator station can be provided at only one end of the platform. The operators can ensure the platform is properly secured to the wall. For example, an operator can adjust mullions (which at times can jam in their corresponding guides) and can, where appropriate, tether the platform to the building with lanyards.

The operator stations 128, 130 include a railing 132 and a floor 133. The railing 132 at least partially surrounds the operator stations 128, 130 and helps to retain the operator within the operator stations 128, 130 of the platform 106. In some embodiments, a top of the 132 railing is at least about four feet from the floor 133. The floor 133 of the operator stations 128, 130 are configured to provide a rigid support for the operator to support himself upon.

The operator stations 128, 130 of the platform 106 are positioned adjacent the cleaning structure 108 and extend along at least a portion of the length L of the platform 106. In some embodiments, the platform 106 includes a single operator station 128 that extends along a portion of the length L of the platform 106. In other embodiments, the platform 106 includes a single operator station 128 that extends along the entire length L of the platform 106. In other embodiments still, the platform 106 includes multiple operator stations 128, 130 that extend along a portion of the length L of the platform 106. In some embodiments, the operator stations 128, 130 are connected to one another so that an operator can travel between operator stations 128, 130. In some embodiments, the operator stations 128, 130 are connected to one another by way of a walkway. In some embodiments, the walkway is positioned at the back side 126 of the platform 106. In some embodiments, the walkway is another platform attached to the backside 126 of the platform 106. In some embodiments, the operator can travel underneath the cleaning structure 108 so as to gain access to both operator stations 128, 130.

The platform 106 can also include an obstruction bar positioned at a bottom side 109 of the platform 106. The obstruction bar is configured to alter the operations of the washing apparatus 100 when the obstruction bar contacts an obstruction upon the upright surface. In some embodiments, the obstruction bar can control the operation of the hoist system 110 and the operation of the cleaning structure 108 so that when an obstruction is encountered, the obstruction bar automatically shuts down the operation of the hoist system 110 and/or the cleaning structure 108. The obstruction bar interfaces with mechanical or electronic control devices such that actuation of the bar by an obstruction causes the hoist system and or cleaning structure to shut down. In the case where the cleaning structure is a retrofit device used to retrofit an existing platform by adding the cleaning structure to the bottom of the platform, the existing wheels and obstruction bar of the platform can be removed to facilitate mounting the cleaning structure. In such a case, the cleaning structure can include an obstruction bar that performs the same function as the obstruction bar removed from the platform.

With continued reference to FIGS. 1 and 2, the cleaning structure 108 is adapted to contact the upright surface 102 during cleaning. Specifically, the cleaning structure 108 is configured to automatically clean the upright surface 102 of the structure 104 as the washing apparatus 100 travels in the direction 118 along the upright surface 102 during operation. The cleaning structure 108 uses a power source, such as a battery, power cord or other external power source, and a water source (i.e. a hose) along with a spray nozzle to clean the upright surface 102. In some examples, the power cord and hose can be routed from the roof top. Automatic window washing systems have been described in U.S. Pat. No. 8,434,504; US 2014/0109932; U.S. Pat. No. 6,158,678; U.S. Pat. No. 5,249,326; U.S. Pat. No. 5,901,720; U.S. Pat. No. 5,890,250; U.S. Pat. No. 8,790,468; U.S. Pat. No. 7,972,446; U.S. Pat. No. 6,550,090; U.S. Pat. No. 6,170,109; U.S. Pat. No. 7,665,173; and U.S. Provisional Application Ser. No. 62/346,261, filed Jun. 6, 2016, entitled “WASHING APPARATUS AND METHODS,” and having Attorney Docket No. 17612.0001USP1, the entire disclosures of which are incorporated herein by reference. In the depicted embodiment, a pair of fans or thrusters are shown on the cleaning structure 108; however, such fans are optional.

The cleaning structure 108 for the washing apparatus 100 can include a cleaning element 134 adapted to contact the upright surface 102, such as the side of the building, during cleaning. In the example shown, the cleaning element 134 can be rotatable about an axis 136. In some embodiments, the cleaning element 134 is rotatable about the axis by way of a single motor or a plurality of motors (not shown). The axis 136 will be generally parallel to the upright surface 102, generally in a horizontal direction and extend generally about the length L of the platform. The cleaning element 134, as shown, can generally extend along least a portion of the length L of the platform 106. In some embodiments, the cleaning element 134 extends about the full length L of the platform 106. In some embodiments, the cleaning element 134 extends more than the full length L of the platform 106 and extends past the platform 106. The cleaning element 134 can be a pad-type brush, a type of brush often used in commercial carwashes (e.g., having flexible radial cleaning elements such as strips, flaps. etc.), or other similar cleaning element. In certain examples, the cleaning structure 108 can be mounted above the platform 108, below the platform 106 or at a front side 124 of the platform 106. In some examples, length of the cleaning structure 108 can be shorter than the length L of the platform 106 or longer than the length L of the platform. In some examples, the position of the cleaning structure 108 can be adjusted along the length of the platform 106; in such cases the cleaning structure 108 can have a counterbalance system that adjusts the balance of the platform 106 as the cleaning structure 108 is moved.

The cleaning structure 108 includes a frame 138 to which the cleaning element 134 is rotatably attached. The frame 138 is configured to be supported by the platform 106. Specifically, the frame 138 is secured to the platform 106. In some embodiments, the frame 138 is pivotally mounted to the platform 106. In other embodiments, the frame 138 is immovably mounted to the platform 106. In still other embodiments, the frame 138 is slidably mounted to the platform 106 so as to allow the cleaning structure 108 to be positioned at a variety of different locations along the length L of the platform 106. In the depicted embodiment, the frame 138 of the cleaning structure 108 is mounted to and on top of the rails 132 of the platform 106. In some embodiments, the frame 138 of the cleaning structure 108 is mounted at the bottom side 109 of the platform 106.

With continued reference to FIGS. 1 and 2, the washing apparatus 100 includes a hoist system 110 that is constructed and arranged to move the washing apparatus 100 along the upright surface 102 of the structure 104 with lift cables 142, 144. The hoist system 110 is configured to attach the washing apparatus 100 to a lift system 146 positioned on the roof 112.

The hoist system 110 includes at least one winch 148 attached to the platform 106. In some embodiments, the winch 148 is positioned at either end of the platform 106 and operated by the operator from either operator station 128, 130. In some embodiments, the winch 148 can be operated remotely. The winch 148 helps to control and move the lift cable 142 in order to move the washing apparatus 100 vertically relative to the upright surface 102, e.g., along the direction 118 of FIG. 1. In some embodiments, the other cable 144 not attached to the winch 148 can be attached to an automatic spool or another winch 150. In some embodiments, the winches 148, 150 are constructed and arranged so as to operate in unison so as to keep the washing apparatus 100 generally level with horizontal as the washing apparatus 100 travels along the upright surface 102. In some examples, the winch/winches can be located on the platform 108 or on the roof 112 (e.g., mounted to portions of the lift system 146 or incorporated as part of a hoist or crane of an existing building maintenance unit.

The cables 142, 144 are also attached to the lift system 146. The lift system 146 includes a pair of base members 152, 154 that are constructed and arranged to interface with the roof 112 so as to provide stability to the washing apparatus 100 during operation. The base members 152, 154 can also be referred to as davit arms and be configured to mate with preexisting fixed features in the roof 112 of the structure (e.g. the davit arms). Such preexisting features include channels, apertures, or other similar like receiving features. In other embodiments, the cables 142, 144 are attached to an elevated crane hoist system fixed to the roof. Such a crane hoist system can be configured to lift the washing apparatus 200 over the parapet wall 116 and onto the roof 112 for both launching and taking in the washing apparatus. In some embodiments, the washing apparatus 100 can be launched from the roof 112. In other embodiments, the washing apparatus 100 can be lifted from the ground 114.

The first base member 152 is configured to be positioned on the roof 112 adjacent the parapet wall 116 and be attached to the first lift cable 142. The first base member 152 also includes a weighted outrigger 156 that is spaced away from the first base member 152 and the parapet wall 116. Weight can be added to the weighted outrigger 156 so that proper washing apparatus stability can be achieved depending on both weather conditions (e.g., wind) and the contents of the washing apparatus 100 (fluids, tools, operators, etc.).

The second base member 154 is positioned adjacent to the parapet wall 116 of the roof 112 and attached to the second lift cable 144. In some embodiments, the second base member 154 is clamped to the wall 116. In some embodiments, the second base member 154 can include rigging 158 so as to further anchor the second base member 154 to the roof 112.

As shown in FIG. 2, the washing apparatus 100 can include a securing system 160 for retaining the washing apparatus 100 against the upright surface 102 of the structure 104. The securing system 160 can include a variety of different features to allow the washing apparatus 100 to be secured to the upright surface 102 to aid in reducing the likelihood of the washing apparatus 100 from swinging along the upright surface 102 or away from the upright surface 102. Stabilization can be provided by tethers having mullions received in vertical mullion guides incorporated into the upright surface 102 or by lanyards that attach to discrete tie-in locations integrated at the upright surface 102.

For example, the securing system 160 of the washing apparatus 100 can include at least one guide 162 that is configured to travel within a channel or corresponding guide (not shown) on the upright surface 102. In some embodiments, the washing apparatus 100 includes a plurality of guides 162 positioned at the front side 124 of the platform 106.

In some embodiments, the securing system 160 is a mullion guide system. In such an embodiment, the guide 162 is configured to travel within a mullion guide track (not shown) attached to the upright surface 102 of the structure 104. In some embodiments, the guides 162 include rollers (not shown) so as to allow the guide 162 to slide within the mullion track. The mullion track and guides 162 are configured to withstand a force from any direction to aid in retaining the washing apparatus 100 against the upright surface 102 of the structure 104. In some embodiments, the washing apparatus 100 includes a plurality of guides 162 positioned at the front side 124 of the platform 106. The guides 162 can be adjustable and movable along the front side 124 of the platform 106 to as to accept a variety of different mullion tracks widths on different upright surfaces 102 of different structures 104.

In another example, the securing system 160 of the washing apparatus 100 can include anchor points to allow the operator to anchor the washing apparatus 100 to the upright surface 102 of the structure 104. The upright surface 102 can include sets of tie-in point or loops. In some embodiments, the platform 106 includes relatively short lanyards that hook/secure into the tie-in points. In other examples still, the washing apparatus 100 can use a guide line 164 that is routed along the height of the upright surface 102 of the structure 104 and tethered to the washing apparatus 100 and to a point at the roof 112. In such an example, the guide line 164 can be periodically anchored to the upright surface 102, thereby reducing the opportunity for the washing apparatus 100 to swing away from or along the upright surface 102.

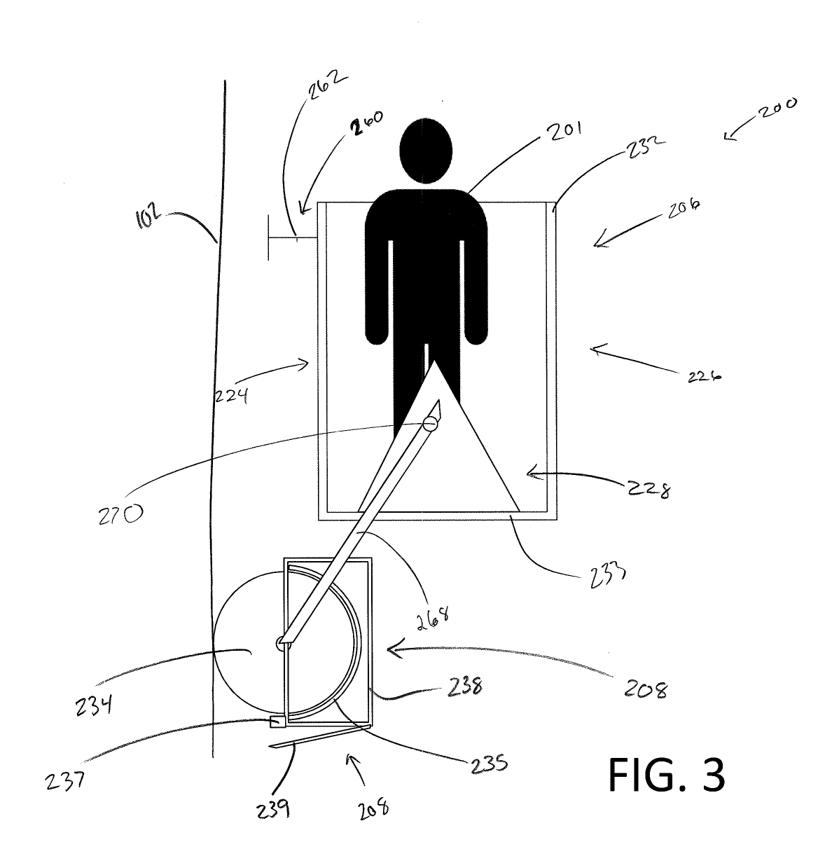

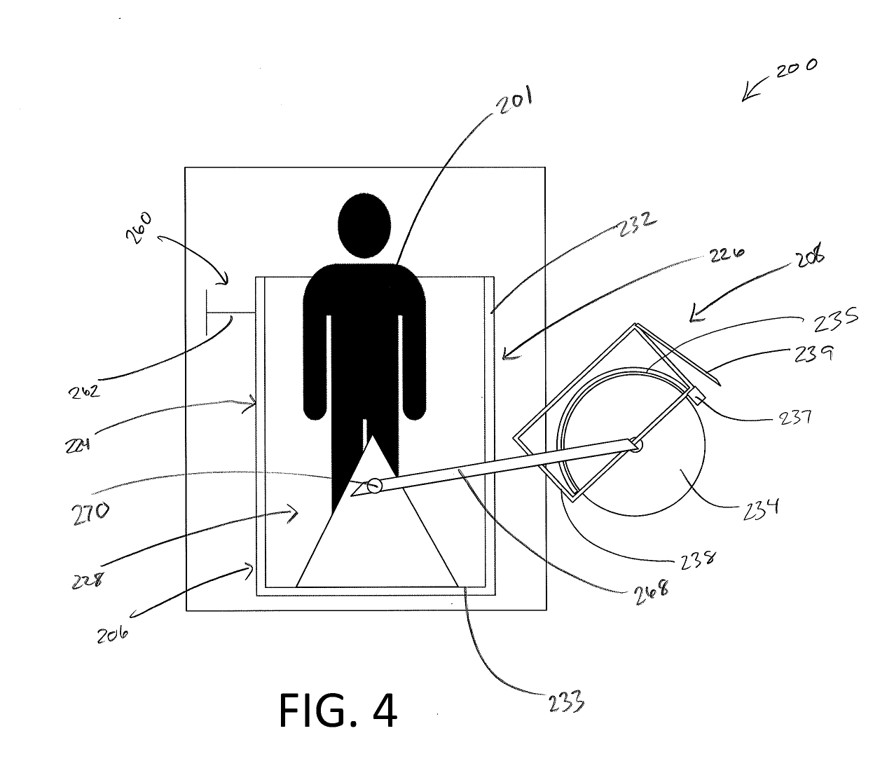

FIGS. 3 and 4 show schematic side views of a washing apparatus 200 according to one embodiment of the present disclosure. Similar to the washing apparatus 100 described above, the washing apparatus 200 includes a platform 206 with an operator station 228; a cleaning structure 208 supported by the platform 206; and a securing system 260 for securing the washing apparatus to the upright surface 102. In some embodiments, the washing apparatus 200 can also include a hoist system for attaching the washing apparatus 200 to a lift system at the roof 112 of the structure 104. Both the hoist system and lift systems of the washing apparatus 200 can be substantially similar to those described above (i.e., hoist system 110 and lift system 146) and therefore will not be described in further detail here.

As shown, an operator 201 is positioned within the operator station 228 on the platform 206. Further, the operator station 228 includes rails 232 that extended to a height above a floor 233 so as to aid in retaining the operator 201 within the operator station 228 during operation.

The platform 206 has a front side 224 and a back side 226. The front side 224 is constructed and adapted to be closely positioned adjacent the upright surface 102 during the operation of the washing apparatus 200. Further, as part of the securing system 260, at the front side 224, at least one guide 262 is positioned to allow the washing apparatus 200 to be supported and connected to the upright surface 102. In some embodiments, the guide 262 is a mullion guide 262 that is configured to be received by an additional mullion guide or track along the upright surface 102.

The cleaning structure 208 is pivotally connected to the platform 206 by way of at least one support arm 268 to allow the cleaning structure 208 to be pivoted toward and away from the upright surface 102 via a pivot point 270 at a side of the platform between a raised and lowered position. In some embodiments, the pivoting of the cleaning structure 208 can be done automatically via a motor or via a counterforce such as weights. In other embodiments, the pivoting of the cleaning structure 208 about the pivot point 270 can be done manually by way of a rope or other similar method. In some embodiments, the at least one support arm 268 is lockable so as to preserve the position of the cleaning structure 208 in a desired orientation. In other embodiments, the opposite side of the cleaning apparatus 200 includes a second support arm that is configured to move in unison with the first support arm 268. The cleaning structure 208 includes a cleaning element 234, a shroud 235, a spray nozzle 237, and a frame 238 with an obstruction bar 239. In some examples, the obstruction bar 239 replaces the obstruction bar that would ordinarily be positioned at the bottom of the platform 206 and provides the same function of being able to control certain operations of the cleaning structure 208 and the platform 206, similar to the obstruction bar described above with respect to the platform 106.

The cleaning element 234 is substantially similar to the cleaning element 134 described above and is rotatable about the frame 238 of the cleaning structure 208. The shroud 235 is configured to at least partially surround the cleaning element 234 to prevent unwanted overspray caused by the rotation of the cleaning element 234. The spray nozzle 237 is configured to deliver a liquid from a liquid source (i.e., a tank or water hose) to the upright surface 102. The frame 238 is configured to hold the cleaning element 234 and to attach to the support arm 268 for mounting the cleaning apparatus 208 to the platform 206. Further, the obstruction bar 239 of the frame 238 is configured to protect the spray nozzle 237 from obstructions along the upright surface 102, such as ledges.

During operation alongside the upright surface 102, the cleaning structure 108 is in a lowered position, as shown in FIG. 1 so that the cleaning element 234 contacts the upright surface 102. Further, at such a time, the securing system 260 is configured to help aid in securing the washing apparatus 200 to the upright surface 102 (such securing is not shown). When the cleaning operation is complete and the washing apparatus 200 is either positioned near the ground 114 or near the parapet wall 116 at the roof 112, the cleaning structure 208 is pivoted to the raised position, as shown in FIG. 2. This allows the platform 206 to sit flat on the ground 114 or on the roof 116. Further, by pivoting the cleaning structure 208 to the raised position, the washing apparatus 200 is reduced in height, thereby making the washing apparatus 200 easier to rise above the parapet wall 116 or above an edge of the roof 112.

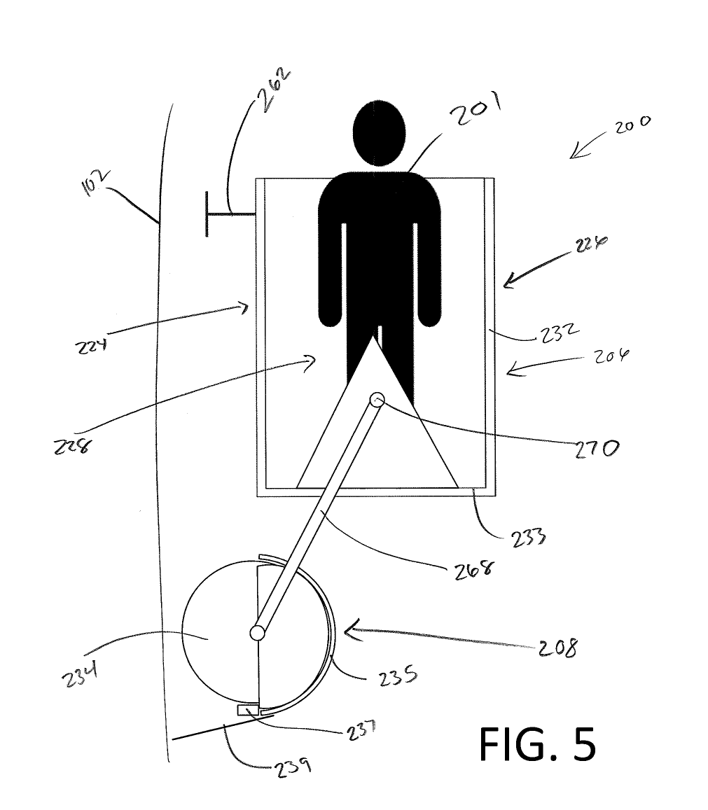

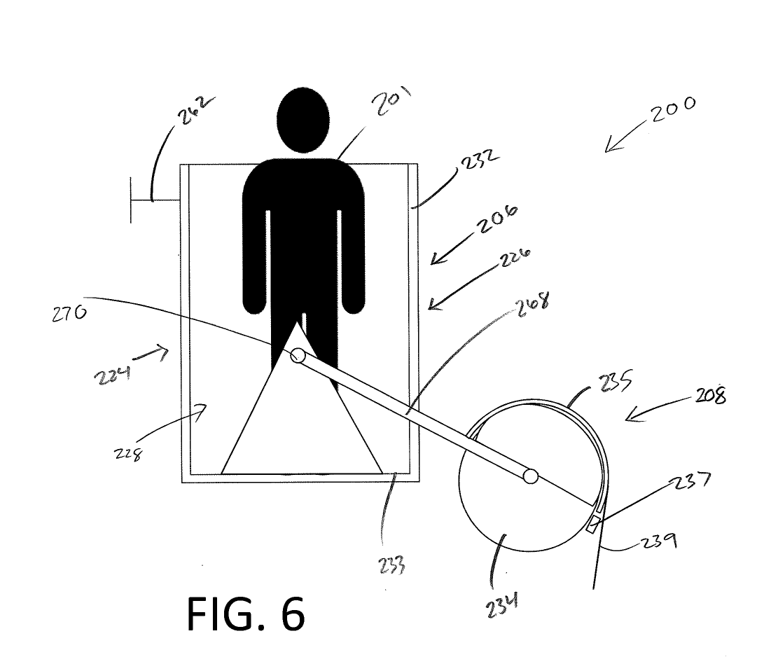

FIGS. 5 and 6 show schematic side views of the washing apparatus 200. The washing apparatus 200 is generally identical to that shown in FIGS. 3 and 4 with the exception of the support bar 268 being attached directly to the cleaning element 234 of the cleaning structure 208 instead of to the frame 238. As shown, the cleaning structure 208 still includes the obstruction bar 239 but does not include a frame. FIG. 6 shows the cleaning structure 208 in a partially raised position.

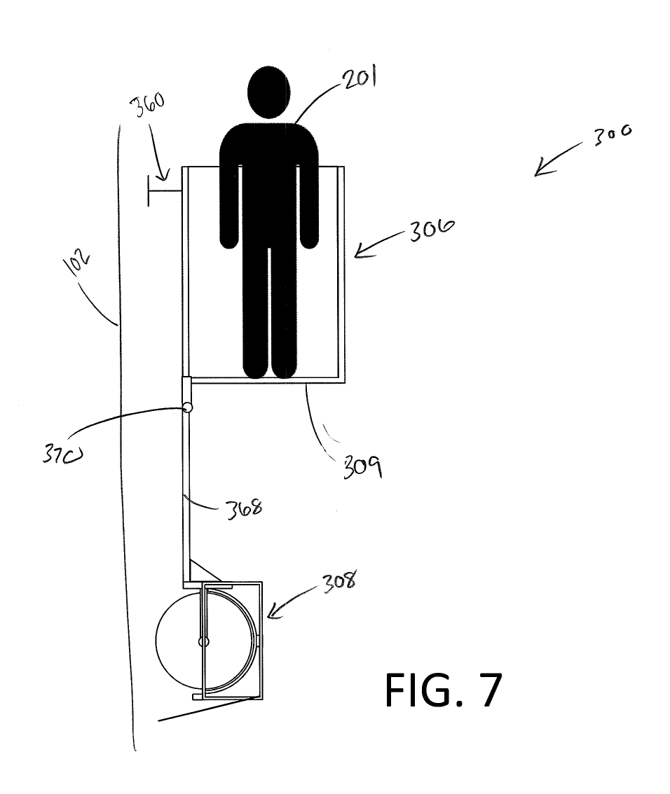

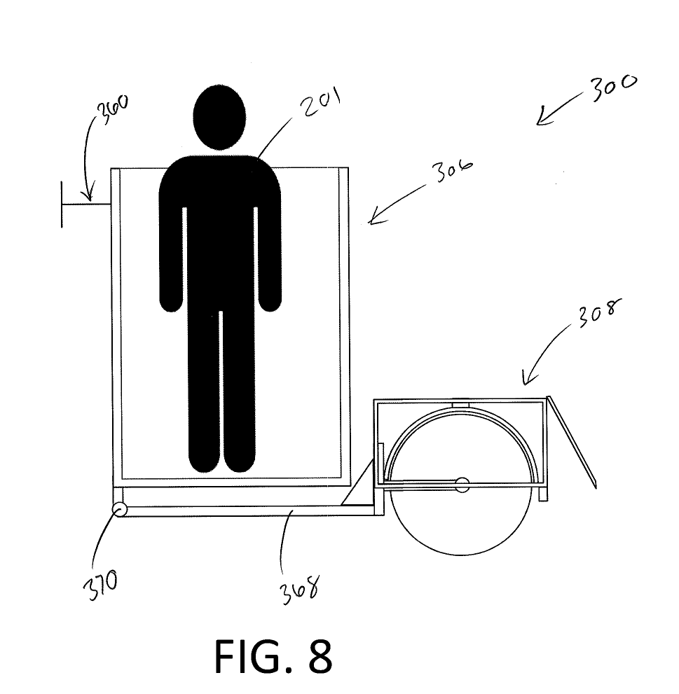

FIGS. 7 and 8 show schematic side views of a washing apparatus 300. The washing apparatus 300 is substantially similar to the washing apparatus 200 described above with the exception of an extended support arm 368 to support a cleaning structure 308 and a pivot point 370 located at a bottom side 309 of a platform 306. The extended support arm 368 and pivot point 370 allow the cleaning structure 308 to pivot and hang in the operating position with the support bar 368 in a generally vertical orientation. This reduces strain on the pivot point 370 by the support arm 368 when the cleaning structure 308 is in the operation position. Further, it also reduces the need to heavily brake or lock the support arm 368 in place in the operating position.

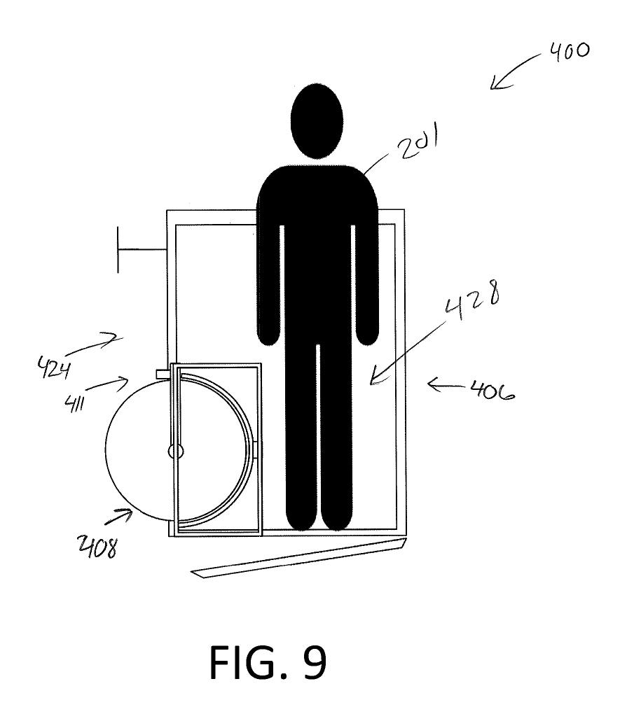

FIG. 9 shows schematic side view of a washing apparatus 400. The washing apparatus 400 is substantially similar to the washing apparatuses 100, 200, 300 described above with the exception that the cleaning structure 408 is mounted directly to a lower portion 411 of a front side 424 of a platform 406. The cleaning structure 408 is configured to be fixedly mounted so as to allow the operator 201 access to the cleaning structure 408 from an operator station 428. In some embodiments, the cleaning structure 408 is positioned along the entire length of the platform 406 and, in other embodiments, the cleaning structure 408 is positioned along a portion of the length of a platform 406.

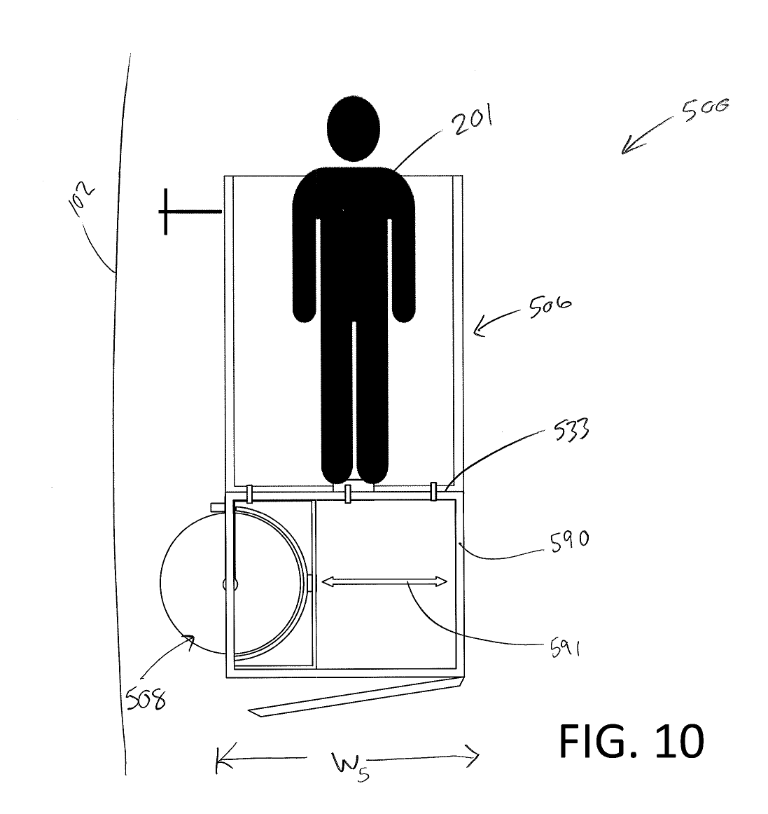

FIG. 10 shows a schematic side view of a washing apparatus 500. The washing apparatus 500 is substantially similar to the washing apparatuses 100, 200, 300, 400 described above with the exception of a cleaning structure extension 590. The cleaning structure extension 590 is fixedly mounted to a bottom side 533 of a platform 506 of the washing apparatus 500. The washing apparatus 500 includes a cleaning structure 508 that is movable along a width W5 of the cleaning structure extension 590 so as to be slidably adjusted. Such sliding movement (as shown by an arrow 591) allows the cleaning structure 508 to be adjusted depending on the upright surface 102. In some embodiments, the cleaning structure 508 is spring loaded so as to allow the cleaning structure 508 to slide along the width W5 of the cleaning structure extension 590 when the cleaning structure 508 encounters an obstruction on the upright surface 102. In such an embodiment, once the cleaning structure 508 clears the obstruction, it can spring back into place in a direction toward the upright surface 102.

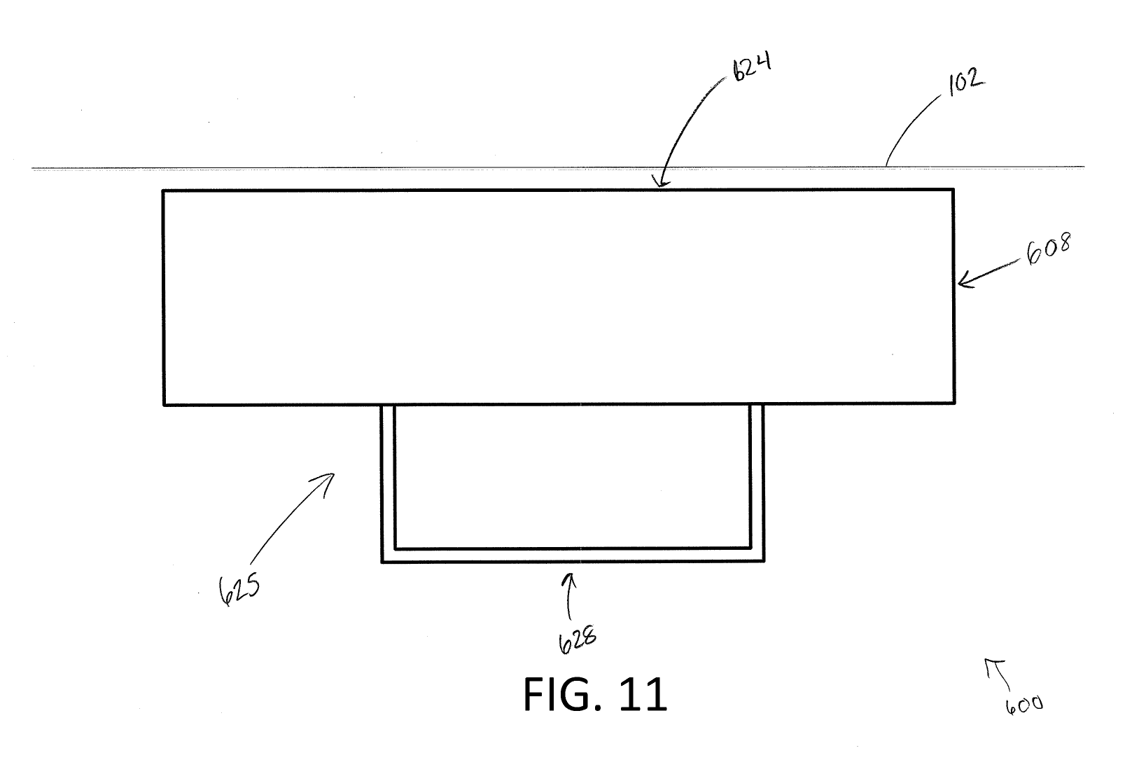

FIG. 11 shows a schematic top view of a washing apparatus 600. The washing apparatus 600 is substantially similar to the washing apparatuses 100, 200, 300, 400, 500 described above with the exception that an operator station 628 is secured to a rear 625 of the washing apparatus 600. Specifically, a cleaning structure 608 is positioned at a front side 624 of the washing apparatus 600. The cleaning structure 608 is longer than the operator station 628. In some examples, the operator station 628 is movable along the length of the cleaning structure 608.

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

We claim:

1. A washing apparatus for cleaning an upright surface of a structure, the washing apparatus comprising:
a platform including an operator station, the platform adapted to move along the upright surface during cleaning, wherein the platform is positionable along the upright surface along a length of the platform;
a powered cleaning structure having cleaning elements adapted to contact the upright surface during cleaning, the powered cleaning structure being supported by the platform along at least a portion of the length of the platform; and
a hoist system constructed and arranged to move the platform along the upright surface of the structure with lift cables.

2. The washing apparatus of claim 1, wherein the platform includes a second operator station, and wherein the operator stations are positioned adjacent the powered cleaning structure.

3. The washing apparatus of claim 1 wherein the operator stations are connected by a walkway extending along a portion of the length of the platform.

4. The washing apparatus of claim 1, wherein the powered cleaning structure is pivotally supported by the platform, the powered cleaning structure being rotatable about the platform.

5. The washing apparatus of claim 1, wherein the hoist system includes a pair of base members configured to mount to a roof top, and wherein at least one base member includes a weighted outrigger.

6. The washing apparatus of claim 5, wherein the at least one base member is configured to clamp to a parapet wall.

7. The washing apparatus of claim 1, wherein the hoist system includes a boom configured to lift the platform over a parapet wall.

8. The washing apparatus of claim 1, wherein the operator station includes a floor and railings raised from the floor and at least partially surrounding the floor.

9. A washing apparatus for cleaning an upright surface of a structure, the washing apparatus comprising:
a platform including an operator station and a railing at least partially surrounding the operator station, the platform adapted to move along the upright surface during cleaning, the platform being positionable along the upright surface along a length of the platform;
securing features attached to the platform, wherein the securing features are configured to secure the platform to the upright surface;
a powered cleaning structure having cleaning elements adapted to contact the upright surface during cleaning, the powered cleaning structure being supported by the platform along at least a portion of the length of the platform; and
a hoist system attached to the platform, the hoist system being configured to move the platform along the upright surface of the structure with lift cables.

10. The washing apparatus of claim 9, wherein the platform includes a second operator station, and wherein the operator stations are positioned adjacent the powered cleaning structure.

11. The washing apparatus of claim 9, wherein the operator stations are connected by a walkway extending along a portion of the length of the platform.

12. The washing apparatus of claim 9, wherein the powered cleaning structure is pivotally supported by the platform, the powered cleaning structure being rotatable about the platform.

13. The washing apparatus of claim 9, wherein the securing features are configured to interface with a mullion guide of the upright surface of the structure.

14. The washing apparatus of claim 9, wherein the securing features include attachment points for fixedly securing the platform to the upright surface of a structure.

15. The washing apparatus of claim 9, wherein the securing features are configured to interface with mullion guides of the upright surface of a structure.

16. A washing apparatus for cleaning an upright surface of a structure, the washing apparatus comprising:
a platform including an operator station and a railing at least partially surrounding the operator station, the platform adapted to move along the upright surface during cleaning, the platform being positionable along the upright surface along a length of the platform, wherein the operator station extends along the length of the platform;
securing features attached to the platform, wherein the securing features are configured to secure the platform to the upright surface;
a powered cleaning structure having cleaning elements adapted to contact the upright surface during cleaning, the powered cleaning structure being supported by the platform along at least a portion of the length of the platform; and
a hoist system attached to the platform, the hoist system being configured to move the platform along the upright surface of the structure with lift cables.

17. The washing apparatus of claim 16, wherein the powered cleaning structure is pivotally supported by the platform, the powered cleaning structure being rotatable about the platform.

18. The washing apparatus of claim 16, wherein the securing features are configured to interface with a mullion guide of the upright surface of the structure.

19. The washing apparatus of claim 16, wherein the securing features include attachment points for fixedly securing the platform to the upright surface of a structure.
